(19) United States
(12) Patent Application Publication
(10) Pub. No.: US 2003/0059209 A1
(43) Pub. Date: Mar. 27, 2003

(54) Method to record editable marker specific information, and apparatus and information storage medium thereof

(75) Inventor: Sung-wook Park, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/255,090

(22) Filed: Sep. 26, 2002

(30) Foreign Application Priority Data
Sep. 27, 2001 (KR) 2001-60241
Aug. 30, 2002 (KR) 2002-51880

(51) Int. Cl. H04N 5/781

(52) U.S. Cl. 386/95; 386/125

(57) ABSTRACT

An apparatus and method thereof to record maker information on an information storage medium include a buffer, a recording unit, and a controller. The buffer receives and buffers a bit stream comprising digital broadcasting programs. The recording unit receives the buffered digital broadcasting programs on the information storage medium. The controller controls the recording unit to record the digital broadcasting programs, to record maker information corresponding to the digital broadcasting programs in an extended information area of a management information area of the information storage medium, in which navigation data of the digital broadcasting programs is recorded, and to record maker information pointers pointing out the maker information in a program management information area of the management information area in which management information on the digital broadcasting programs is recorded to correspond to the digital broadcasting programs.

### CROSS-REFERENCE TO RELATED APPLICATIONS

This application is based upon and claims the benefit of Korean Application Nos. 01-60241 and 02-51880 filed Sep. 27, 2001 and Aug. 30, 2002, respectively, in the Korean Intellectual Property Office, the contents of which are incorporated herein by reference.

### BACKGROUND OF THE INVENTION

1. Field of the Invention

The present invention relates to recording of digital broadcasting programs, and more particularly, to a method of and an apparatus to record editable maker information on digital broadcasting programs having different data structures, and an information storage medium thereof.

2. Description of the Related Art

Digital broadcasting programs can be broadcast in a same area as conventional broadcasting programs via a plurality of broadcasting systems or scramble methods. Although the same broadcasting system is used, a data structure of a transmitted program may be different in the same area. For example, digital broadcasting companies such as Korea Broadcasting System (KBS), Mutual Broadcasting Corporation (MBC), etc., produce and broadcast programs having various data structures. Also, video and audio data of programs according to Digital Video Broadcasting (DVB) standards are based on Motion Picture Experts Group (MPEG) 2 and MPEG1/2, respectively. Video and audio data of programs according digital ground-wave propagation broadcasting standards are based on MPEG2 and Audio Coding (AC) 3, respectively.

A recording apparatus, which receives and broadcasts conventional digital broadcasting programs, records maker information specified by a maker of the recording apparatus as disc information in a navigation data area. Because the makers of the recording apparatuses specify the maker information, detailed contents of the maker information vary according to each maker. In case where the maker information having different data structures is recorded only as the disc information, although contents of a predetermined program are edited, i.e., changed, deleted, etc., the maker information recorded as the disc information is inconsistently edited.

In one instance, a user A records a program A on a disc using a recording/reproducing apparatus A capable of recording ground-wave propagation broadcasting programs. The user A then proceeds to record the maker information of the recording/reproducing apparatus A as the disc information, and lends the disc to a user B. The user B has a recording/reproducing apparatus B to record video broadcasting programs. When the user B records a program B on the disc to overwrite the program B on the program A, at least a portion of the program A is deleted. Here, the recording/reproducing apparatus B cannot recognize the maker information of the user A recorded as the disc information along with the program A and cannot also recognize that the maker information recorded by the recording/reproducing apparatus A is related to the program A. Thus, although at least the portion of the program A is deleted, the maker information on the program A is left. Thereafter, when the user A puts the disc into the recording/reproducing apparatus A, the recording/reproducing apparatus A can recognize the previously recorded maker information. For example, if at least the portion of the program A, which is the maker information deleted by the recording/reproducing B, is designated as representative information to guide the program A, data recorded in the designated portion is reproduced as representative information for the program A. However, because the program B is already recorded in the designated portion, unexpected data (a portion of the program B) instead of the designated portion may be reproduced.

### SUMMARY OF THE INVENTION

To solve the above-described problems, it is an object of the present invention to provide a method of, an information storage medium, and an apparatus which are capable of securing an area, in which management information to navigate contents having new data structures can be recorded; even in a recording/reproducing apparatus that does not support recording of digital broadcasting programs having new data structures. The method, the information storage medium, and the apparatus of the present invention are also capable of recording editable management information when editing corresponding digital broadcasting programs.

Additional objects and advantages of the invention will be set forth in part in the description which follows and, in part, will be obvious from the description, or may be learned by practice of the invention.

To achieve the above and other objects, the present invention provides a method and an apparatus to record maker information on predetermined digital broadcasting programs in an editable data structure so as to cope with an edition of corresponding digital broadcasting programs between recording/reproducing apparatuses which record/reproduce digital broadcasting programs having different data structures.

Accordingly, to achieve the above and other objects, there is provided a method of recording maker information on an information storage medium. Digital broadcasting programs are received and recorded. The maker information corresponds to the digital broadcasting programs in an extended information area of a management information area of the information storage medium, in which navigation data is recorded. Maker information pointers point out the maker information in a program management information area of the management information area in which management information of the digital broadcasting programs is recorded to correspond to the digital broadcasting programs.

To achieve the above and other objects, the present invention provides a method of recording maker information on an information storage medium. Digital broadcasting programs are received and recorded. The maker information corresponding to the digital broadcasting programs in a program management information area of a management information area of the information storage medium, where the management information area includes navigation data in which management information of the digital broadcasting programs is recorded to correspond to the digital broadcasting programs.

The maker information includes maker identifier and maker specific information. The maker specific information may be the navigation data of a predetermined digital broadcasting program.

To achieve the above and other objects, there is provided an apparatus to record maker information on an information storage medium. The apparatus includes a buffer, a recording unit, and a controller. The buffer receives and buffers a bit stream including digital broadcasting programs. The recording unit records the buffered digital broadcasting programs on the information storage medium. The controller controls the recording unit to record the digital broadcasting programs, to record the maker information corresponding to the digital broadcasting programs in an extended information area of a management information area of the information storage medium, in which navigation data of the digital broadcasting programs is recorded, and to record maker information pointers pointing out the maker information in a program management information area of the management information area in which management information on the digital broadcasting programs is recorded to correspond to the digital broadcasting programs.

To achieve the above and other objects, the present invention provides an apparatus to record maker information on an information storage medium. The apparatus includes a buffer, a recording unit, and a controller. The buffer receives and buffers a bit stream including digital broadcasting programs. The recording unit records the buffered digital broadcasting programs on the information storage medium. The controller controls the recording unit to record the digital broadcasting programs and record the maker information corresponding to the digital broadcasting programs in a program information area of a management information area of the information storage medium, where the management information area includes navigation data in which management information of the digital broadcasting programs is recorded to correspond to the digital broadcasting programs.

To achieve the above and other objects, there is provided an information storage medium including digital broadcasting programs, maker information, and maker information pointers. The maker information corresponds to the digital broadcasting programs and is recorded in an extended information area of a management information area in which navigation data necessary to reproduce, edit, and search the digital broadcasting programs is recorded. The maker information pointers are recorded in a program management information area of the management information area in which the management information of the digital broadcasting programs is recorded to correspond to the digital broadcasting programs.

To achieve the above and other objects, there is provided an information storage medium including digital broadcasting programs and maker information. The maker information is recorded in a program management information area of a management information area in which navigation data necessary to reproduce, edit, and search the digital broadcasting programs is recorded to correspond to the digital broadcasting programs.

To achieve the above and other objects, the present invention provides a method of recording maker information on an information storage medium, including receiving and recording digital broadcasting programs. Navigation data is recorded in a program management information area of the information storage medium, the navigation data including the maker information, extended information, program management information, and information to record, reproduce, or edit the digital broadcasting programs, wherein the extended information includes an area in which information of unspecified contents is recorded. Maker identifiers and maker specific information are recorded in the extended information area pointing out the maker information in the program management information area in which management information of the digital broadcasting programs is recorded to correspond to the digital broadcasting programs.

To achieve the above and other objects, the present invention provides an apparatus to record maker information on an information storage medium, includes a buffer, a recording unit, and a controller. The buffer receives and buffers a bit stream comprising digital broadcasting programs. The recording unit records the buffered digital broadcasting programs on the information storage medium. The controller controls the recording unit to record navigation data in a program management information area of the information storage medium, the navigation data comprising the maker information, extended information, program management information, and information to record, reproduce, or edit the buffered digital broadcasting programs, where the extended information comprises an area in which information of unspecified contents is recorded, and to record maker identifiers and maker specific information in the extended information area pointing out the maker information in the program management information area in which management information of the buffered digital broadcasting programs is recorded to correspond to the digital broadcasting programs.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a block diagram of a recording apparatus according to an embodiment of the present invention;

FIG. 2 is a view of a structure of data recorded on a disc of FIG. 1;

FIGS. 3A and 3B are views of structures of navigation data including maker information according to an embodiment of the present invention;

FIG. 4 is a view of a data structure of program management information, in accordance with FIGS. 3A and 3B recorded on the disc;

FIG. 5 is a view of a structure of navigation data including maker information, according to another embodiment of the present invention;

FIG. 6 is a view of a data structure of program management, in accordance with FIG. 5 recorded on the disc;

FIG. 7 is a view of a data structure of a program defined via the navigation data;

FIG. 8 illustrates the navigation data recorded as a DTV recording manager;

FIG. 9 illustrates program chain general information recorded in PGC information table;

FIG. 10 illustrates program information including maker specific information search pointers;

FIG. 11 illustrates an extended information table;

FIG. 12 illustrates extended information from the extended information table;

FIG. 13 illustrates a data structure of MSI;

FIG. 14 illustrates the navigation data received as the DTV receiving manager; and

FIG. 15 illustrates another example of a structure of the navigation data corresponding to the navigation data shown in FIG. 7.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

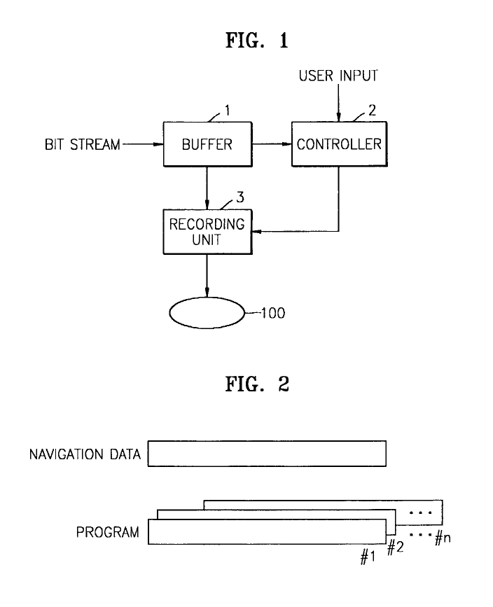

FIG. 1 is a block diagram of a recording apparatus according to an embodiment of the present invention. Referring to FIG. 1, the recording apparatus is used to record programs received from a digital broadcasting station and includes a buffer 1, a controller 2, and a recording unit 3. The buffer 1 receives and buffers a bit stream including a digital broadcasting program, analyzes the bit stream, and attaches a time stamp to the bit stream. The controller 2 controls the recording unit 3 according to a user input to record the digital broadcasting program buffered by the buffer 1 on a disc 100 which is an information storage medium, according to an embodiment of the present invention. Further, the controller 2 controls the recording unit 3 to record maker information on the disc 100 in a data structure according to the present invention.

FIG. 2 is a view of a structure of data recorded on the disc 100 shown in FIG. 1. Referring to FIG. 2, navigation data and programs #1, #2, . . . , and #n are recorded on the disc 100. The programs #1, #2, . . . , and #n denote logical units of contents recorded on the information storage medium, respectively. For example, the programs #1, #2, . . . , and #n may denote one take of the bit stream which is recorded until the recording of the digital broadcasting program is ended. After recording the bit stream, if a portion of one of the programs #i is deleted, the program #i as originally recorded is left as an object, but a time required to reproduce the program #i is reduced. If at least the portion of the program #i is changed or reproduced through an editing process, the program #i is defined to be successively reproduced. The programs #1, #2, . . . , and #n may be called “a program set”. A presentation order of reproducing the program #i is identical to an order of recording the program #i. However, the presentation order may be changed when editing the program #i.

Navigation data includes information necessary to record, reproduce, or edit programs recorded on the information storage medium. For example, the navigation data may include information on the program set, information on each of the programs #i, entry points (reproduction starting points), and information on a reproduction list. In particular, the navigation data includes maker information recorded in the data structure according to an embodiment of the present invention.

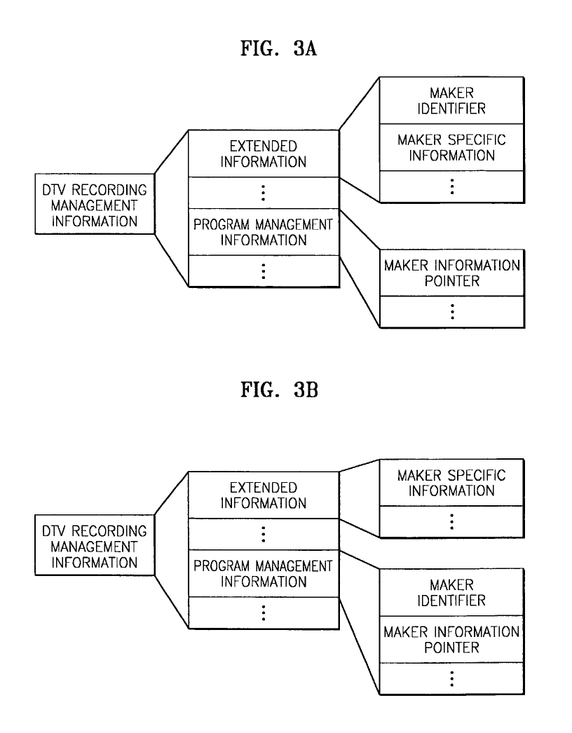

FIG. 3A is a view of a structure of the navigation data including the maker information according to an embodiment of the present invention. Referring to FIG. 3A, the navigation data is recorded as digital television (DTV) recording management information. The DTV recording management information refers to information to manage programs. In the DTV recording management information area, extended information and program management information may be recorded. An extended information area is an area in which additional information on unspecified contents is recorded. At least a portion of the extended information area is used to record the maker information to support various digital broadcasting programs. Thus, the extended information includes maker identifiers and maker specific information which are in the maker information according to an embodiment the present invention. A recording/reproducing apparatus can check via the maker identifiers whether corresponding maker specific information is recorded by a recording/reproducing apparatus manufactured by a maker associated with the corresponding maker specific information or by another maker. Also, the recording/reproducing apparatus can check whether the corresponding maker specific information is recorded in a recognizable data structure.

The program management information includes information to manage programs. For example, the program management information includes a position to record a corresponding program, the total time required to reproduce the corresponding program, and the like. In the program management information area, maker information pointers are recorded to point out positions of the maker specific information included in the extended information, according to an embodiment of the present invention.

FIG. 3B is a view of a structure of the navigation data including the maker information according to another embodiment of the present invention. Referring to FIG. 3B, as described with reference to FIG. 3A, the navigation data is recorded as the DTV recording management information. The DTV recording management information includes the extended information and the program management information. The meanings of the DTV recording management information, the extended information, and the program management information are the same as those described with reference to FIG. 3A. However, positions to record the maker identifiers and the maker specific information, which are the maker information, are different from those shown in FIG. 3A. In detail, in an embodiment of FIG. 3B, the extended information area includes the maker specific information. Also, corresponding maker identifiers and maker information pointers are recorded in the program management information area. Thus, the recording/reproducing apparatus can check via the maker information pointers whether the corresponding maker specific information is recorded by the recording/reproducing apparatus made by the maker associated with the corresponding maker specific information or by another maker by reading the maker identifiers before searching for an area in which the maker specific information is recorded. In other words, the recording/reproducing apparatus can check whether the corresponding maker specific information is recognizable. That is, because the maker identifiers are recorded along with the maker information pointers in the program management information area, when desiring to grasp contents of the maker specific information and, if it is determined via the maker identifiers, that corresponding maker specific information is not recognizable, the recording/reproducing apparatus does not need to search for an area in which corresponding data is recorded.

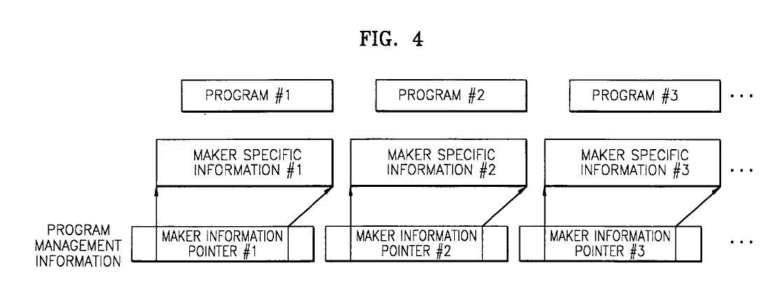

FIG. 4 is a view of a data structure of the program management information in accordance with FIGS. 3A and 3B recorded on the disc 100. Referring to FIG. 4, programs #1, #2, #3, . . . , and maker specific information #1, #2, #3, . . . respectively, correspond to the programs #1, #2, #3, . . . and are recorded on the disc 100. The program management information includes maker information pointers #1, #2, #3, . . . , which respectively point out the maker specific information #1, #2, #3, . . .

As described with reference to FIGS. 3A and 3B, because the maker information pointers which correspond to programs are recorded in a program management information area in which information necessary to edit, search, and reproduce the programs is recorded, the maker information corresponding to the programs is respectively linked to the programs. As a result, when a predetermined program is edited or deleted, maker information corresponding to the predetermined program can be also edited or deleted.

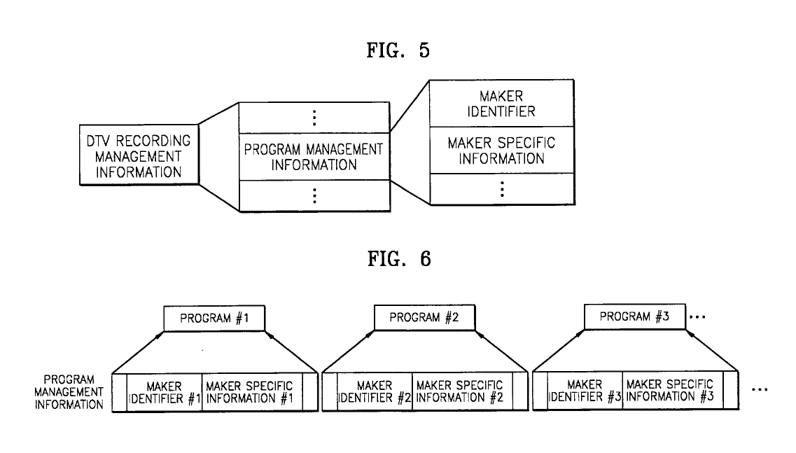

FIG. 5 is a view of a structure of the navigation data including the maker information according to another embodiment of the present invention. Referring to FIG. 5, the navigation data is recorded as the DTV recording management information. The DTV recording management information refers to information to manage programs. The DTV recording management information includes the program management information. In the program management information area, the information to manage the programs is recorded. A portion of the program management information area is used to record the maker information that supports various digital broadcasting programs. In other words, the program management information includes the maker identifiers and the maker specific information which are the maker information. The recording/reproducing apparatus can check via the maker identifiers, whether the corresponding maker specific information is recorded by the recording/reproducing apparatus made by the maker associated with the corresponding maker specific information or by another maker. Further, the recording/reproducing apparatus can check whether the corresponding maker specific information is recorded in a recognizable data structure.

FIG. 6 is a view of a structure of data of FIG. 5 recorded on the disc 100. Referring to FIG. 6, the programs #1, #2, #3, . . . are recorded on the disc 100. Maker identifiers #1, #2, #3, . . . and the maker specific information #1, #2, #3, . . . , respectively, which correspond to the programs #1, #2, #3, . . . are recorded as the program management information on the disc 100. The program management information corresponds to the programs #1, #2, #3, . . . , respectively, so as to point out corresponding programs.

As described with reference to FIG. 5, because the maker identifiers and the maker specific information are recorded as the maker information, respectively, corresponding to programs in the program management information area in which the information necessary to edit, search, and reproduce the programs is recorded, the maker information is linked to the programs. As a result, when a corresponding program is edited or deleted, the maker information corresponding to the program can be also edited or deleted.

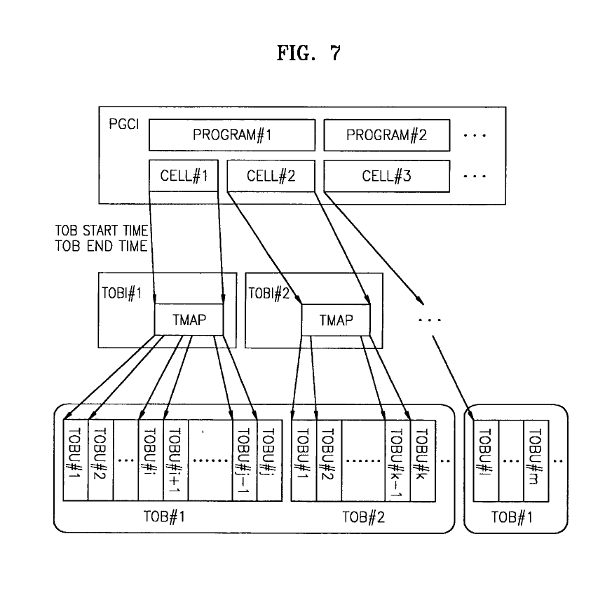

FIG. 7 is a view of a data structure of a program defined via the navigation data. Referring to FIG. 7, a ProGram Chain Information (PGCI) is a data structure to represent a ProGram Chain (PGC). The PGC refers to a chain of (i.e., portions of) programs corresponding to a play list shown to a user. The PGC can be classified into an original PGC that denotes a program set including a chain of programs and a user defined PGC that is defined by the user and includes a chain of portions of programs.

A program includes one or more cells. The cell is a data structure representing a portion of the program and is classified into an original cell that exists in the original PGC and a user-defined cell that exists in the user defined PGC. A program included in a program set includes one or more original cells.

A Transport Object (TOB) denotes a bit stream in which digital broadcasting programs are recorded in real-time. A basic unit constituting the TOB is a Transport OBject Unit (TOBU) which includes MPEG transmission packets transmitted from a digital broadcasting station. The TOBU is a recording unit according to an embodiment of the present invention, and a program is recorded, reproduced, or edited every TOBU. Transport OBject Information (TOBI) is a data structure that provides information on the TOB. As shown in FIG. 7, a time MAP (TMAP) is defined in the TOBI. The TMAP is a data table used to map a presentation time allotted to the TOB to an address of a corresponding TOBU. Thus, the cell points out a start time and an end time of a corresponding TOB of the TMAP, and the TMAP maps an address of a TOBU to be reproduced for a presentation time defined by a start time and an end time.

The data structure of the TOB in an embodiment of the present invention, is based on (Information Technology—Generic coding of moving pictures and associated audio: Systems (ISOIEC 13818-1)). In other words, one TOB includes sub-picture data, real-time data information, and the MPEG transmission packets. The MPEG transmission packets include video data, audio data, and value-added user data. The TOBU constituting the TOB includes a plurality of packs having fixed sizes. In a case where sizes of the packs are identical to sizes of logic blocks used in DVD family discs, the packs can be recorded in the logic blocks defined in the DVD family discs. In other words, the packs are compatible with the DVD family discs.

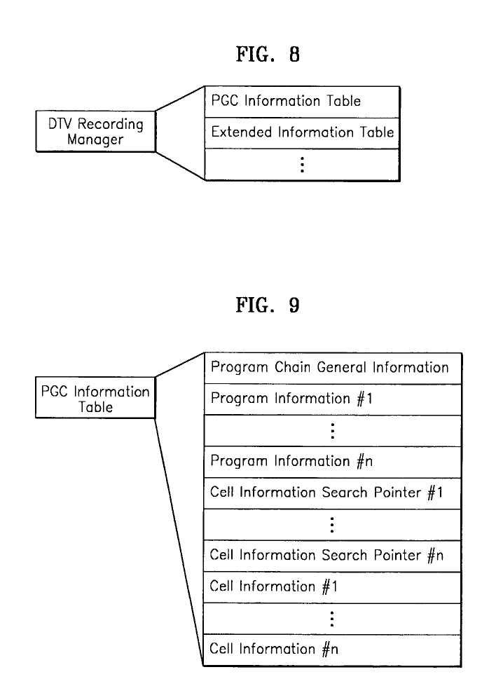

FIGS. 8 through 13 are views of an example of a structure of the navigation data corresponding to the navigation data shown in FIG. 7. Referring to FIG. 8, the navigation data is recorded as a DTV recording manager, which is the DTV recording management information. The DTV recording manager includes a PGC information table and an extended information table.

Referring to FIG. 9, program chain general information is recorded in the PGC information table including general information on a program chain and program information #1, . . . and #n including the program management information on n programs. Cell information search pointers #1, . . . , and #n and cell information #1, . . . , and #n are also recorded in the PGC information table. In each cell information #i, general information of a corresponding cell and cell entry point information are recorded. The cell entry point information points out a start time (a starting point) and an end time (an ending point) of a corresponding cell.

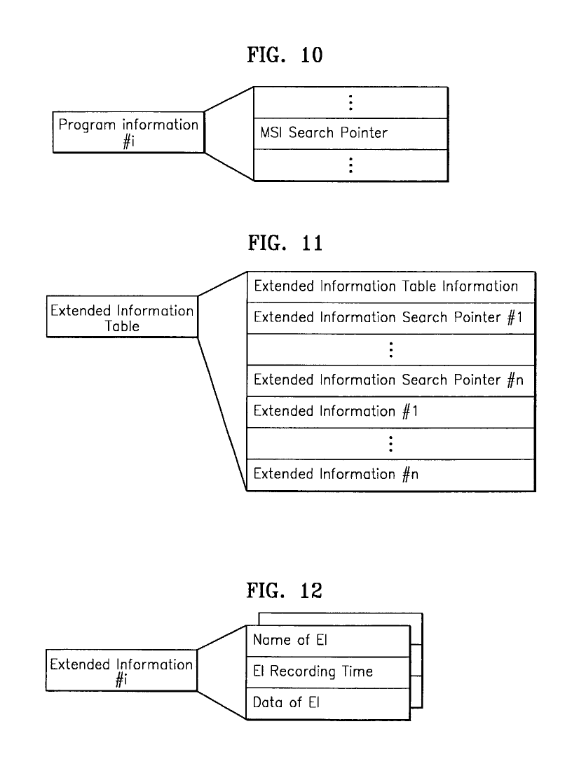

Referring to FIG. 10, program information #i is illustrated including maker specific information (MSI) search pointers, which are maker information pointers. Referring to FIG. 11, an extended information table includes extended information table information, extended information search pointers #1, . . . , and #n, and extended information #1, . . . , and #n. An extended information area is an area in which additional information on unspecified contents is recorded. At least a portion of the extended information area is used to record the maker information that supports various digital broadcasting programs.

Referring to FIG. 12, each extended information #i includes a name of an extended information Name of EI, recording time to extend information, and data of extended information Data of EI.

Referring to FIG. 13, a data structure of MSI is shown, which is an example of the extended information and corresponds to the maker information according to an embodiment of the present invention. The MSI includes a name of an MSI Name of the MSI which are maker identifiers, a recording time for MSI, an MSI Recording Time, and data of MSI Data of the MSI. The MSI Data has an information structure which is specified by a maker. For example, when undefined contents are navigated, the navigation data necessary to reproduce or edit the undefined contents can be recorded. Copyright information, bank account information for electronic commerce, Internet addresses to update contents, and the like may also be recorded. Further, various kinds of information specified by other makers may be recorded.

As described above, according to the data structure shown in FIGS. 8 through 13, because the MSI information corresponding to the programs is recorded in an extended information table, the MSI information is linked to the programs. As a result, when a predetermined program is edited or deleted, maker information corresponding to the predetermined program can be also edited or deleted.

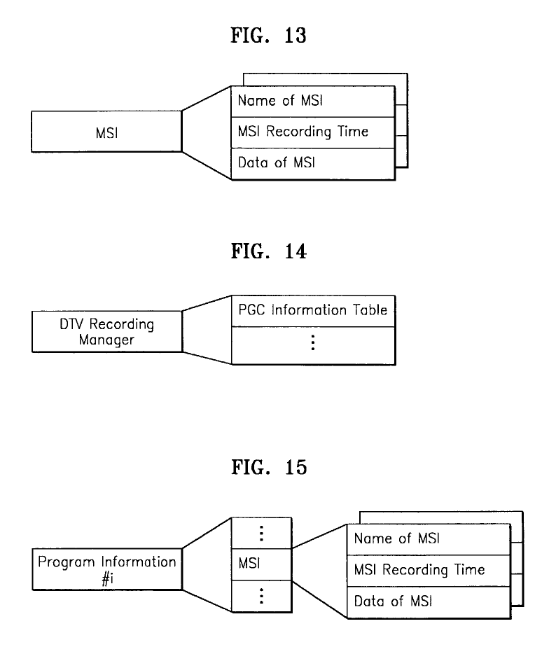

FIGS. 14 and 15 are views of another example of a structure of the navigation data corresponding to the navigation data shown in FIG. 7. Referring to FIG. 14, the navigation data is recorded as the DTV recording manager, which is the DTV recording management information. The DTV recording manager includes the PGC information tables. The PGC information tables have the same data structure as that of the PGC information table described with reference to FIG. 9, and thus its repeated descriptions will be omitted.

Referring to FIG. 15, each program information #i has the MSI, which is the maker information according to an embodiment of the present invention, along with information necessary to reproduce, search or edit the program #i. The MSI includes the MSI Name, which corresponds to maker identifiers, recording time for the MSI Recording Time, and the MSI Data. The MSI Data has an information structure which is specified by the maker. For example, when undefined contents are navigated, the navigation data necessary to reproduce or edit the undefined contents can be recorded. Copyright information, bank account information for electronic commerce, Internet addresses to update contents, and the like may also be recorded. Further, various kinds of information specified by other makers may be recorded.

As described above, according to the data structure shown in FIGS. 14 and 15, because the MSI is recorded in the program information of the PGC information table, the MSI is linked to programs. As a result, when a predetermined program is edited or deleted, the MSI information corresponding to the predetermined information can also be edited or deleted.

Meanwhile, the data structure shown in FIGS. 8 through 15 is matched with the navigation data structure which is supported by the recording/reproducing apparatus to record/reproduce conventional digital broadcasting programs, except the maker information. Thus, the data structure shown in FIGS. 8 through 15 is highly compatible with other recording/reproducing apparatuses.

As described above, according to the present invention, an area, in which navigation data to navigate contents having new data structures can be recorded, can be secured even in an apparatus that does not support the recording of digital broadcasting programs having new data structures. Also, when a predetermined digital broadcasting program is edited, editable navigation data corresponding to the predetermined digital broadcasting program can also be recorded. Further, between apparatuses to record/reproduce digital broadcasting programs having different data structures, maker information on a predetermined digital broadcasting program can be recorded in an editable structure so as to cope with the editing of the predetermined digital broadcasting program.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of recording maker information on an information storage medium, comprising:
receiving and recording digital broadcasting programs;
recording the maker information corresponding to the digital broadcasting programs in an extended information area of a management information area of the information storage medium in which navigation data is recorded; and
recording maker information pointers pointing out the maker information in a program management information area of the management information area in which management information of the digital broadcasting programs is recorded to correspond to the digital broadcasting programs.

2. The method of claim 1, wherein the maker information comprises a maker identifier and maker specific information.

3. The method of claim 2, wherein the maker specific information comprises the navigation data of a predetermined digital broadcasting program.

4. A method of recording maker information on an information storage medium, comprising:
receiving and recording digital broadcasting programs; and
recording the maker information corresponding to the digital broadcasting programs in a program management information area of a management information area of the information storage medium, where the management information area comprises navigation data in which management information of the digital broadcasting programs is recorded to correspond to the digital broadcasting programs.

5. The method of claim 4, wherein the maker information comprises maker identifier and maker specific information.

6. The method of claim 5, wherein the maker specific information comprises the navigation data of a predetermined digital broadcasting program.

7. An apparatus to record maker information on an information storage medium, comprising:
a buffer receiving and buffering a bit stream comprising digital broadcasting programs;
a recording unit recording the buffered digital broadcasting programs on the information storage medium; and
a controller controlling the recording unit to record the digital broadcasting programs, to record the maker information corresponding to the digital broadcasting programs in an extended information area of a management information area, in which navigation data of the digital broadcasting programs is recorded, and to record maker information pointers pointing out the maker information in a program management information area of the management information area in which management information on the digital broadcasting programs is recorded to correspond to the digital broadcasting programs.

8. The apparatus of claim 7, wherein the maker information comprises a maker identifier and maker specific information.

9. The apparatus of claim 8, wherein the maker specific information comprises the navigation data of a predetermined digital broadcasting program.

10. An apparatus to record maker information on an information storage medium, comprising:
a buffer receiving and buffering a bit stream comprising digital broadcasting programs;
a recording unit recording the buffered digital broadcasting programs on the information storage medium; and
a controller controlling the recording unit to record the digital broadcasting programs and record the maker information corresponding to the digital broadcasting programs in a program information area of a management information area of the information storage medium, where the management information area comprises navigation data in which management information of the digital broadcasting programs is recorded to correspond to the digital broadcasting programs.

11. The apparatus of claim 10, wherein the maker information comprises a maker identifier and maker specific information.

12. The apparatus of claim 11, wherein the maker specific information comprises the navigation data of a predetermined digital broadcasting program.

13. An information storage medium comprising:
digital broadcasting programs;
maker information corresponding to the digital broadcasting programs, which is recorded in an extended information area of a management information area in which navigation data necessary to reproduce, edit, and search the digital broadcasting programs is recorded; and
maker information pointers recorded in a program management information area of the management information area in which the management information of the digital broadcasting programs is recorded to correspond to the digital broadcasting programs.

14. The information storage medium of claim 13, wherein the maker information comprises a maker identifier and maker specific information.

15. The information storage medium of claim 14, wherein the maker specific information comprises the navigation data of a predetermined digital broadcasting program.

16. An information storage medium, comprising:
digital broadcasting programs; and
maker information which is recorded in a program management information area of a management information area in which navigation data necessary to reproduce, edit, and search the digital broadcasting programs is recorded to correspond to the digital broadcasting programs.

17. The information storage medium of claim 16, wherein the maker information comprises maker identifiers and maker specific information.

18. The information storage medium of claim 17, wherein the maker specific information comprises the navigation data of a predetermined digital broadcasting program.

19. The information storage medium of claim 17, wherein the maker information comprises a maker identifier and maker specific information.

20. A method of recording maker information on an information storage medium, comprising:
receiving and recording digital broadcasting programs;
recording navigation data in a program management information area of the information storage medium, the navigation data comprising the maker information, extended information, program management information, and information to record, reproduce, or edit the digital broadcasting programs, wherein the extended information comprises an area in which information of unspecified contents is recorded; and
recording maker identifiers and maker specific information in the extended information area pointing out the maker information in the program management information area in which management information of the digital broadcasting programs is recorded to correspond to the digital broadcasting programs.

21. The method of claim 20, wherein the program management information comprises information of a position to record a corresponding program and a total time required to reproduce the corresponding program.

22. The method of claim 20, wherein the navigation data is recorded as a DTV recording manager comprising a PGC information table and an extended information table.

23. The method of claim 22, wherein program chain general information is recorded in the PGC information table comprising general information on a program chain and program information #1, . . . , and #n comprising the program management information of n programs.

24. The method of claim 23, wherein cell information search pointers #1, . . . , and #n and cell information #1, . . . , and #n are recorded in the PGC information table, where general information of a corresponding cell and cell entry point information pointing out a start time and an end time of a corresponding cell, are recorded in each cell information #i.

25. The method of claim 23, wherein each of the program information #1, . . . , and #n comprises maker specific information (MSI) search pointers, which are maker information pointers.

26. The method of claim 25, wherein each of the program information #1, . . . , and #n comprises the MSI to reproduce, search or edit one of the n programs, where the MSI comprises an MSI Name, which corresponds to the maker identifiers, a recording time, and MSI Data.

27. The method of claim 26, wherein the MSI Data comprises copyright information, bank account information for electronic commerce, and Internet, addresses.

28. An apparatus to record maker information on an information storage medium, comprising:
a buffer receiving and buffering a bit stream comprising digital broadcasting programs;
a recording unit recording the buffered digital broadcasting programs on the information storage medium; and
a controller controlling the recording unit to record navigation data in a program management information area of the information storage medium, the navigation data comprising the maker information, extended information, program management information, and information to record, reproduce, or edit the buffered digital broadcasting programs, where the extended information comprises an area in which information of unspecified contents is recorded, and to record maker identifiers and maker specific information in the extended information area pointing out the maker information in the program management information area in which management information of the buffered digital broadcasting programs is recorded to correspond to the digital broadcasting programs.
